(19) United States
(12) Patent Application Publication
(10) Pub. No.: US 2011/0151153 A1
(43) Pub. Date: Jun. 23, 2011

(54) POLYMERIC CONDUCTIVE DONOR

(75) Inventors: THOMAS C. FELDER, Kennett Square, PA (US); Feng Gao, Hockessin, DE (US); Lynda Kaye Johnson, Wilmington, DE (US); Haixin Yang, Chapel Hill, NC (US)

(73) Assignee: E.I. DU PONT DE NEMOURS AND COMPANY, Wilmington, DE (US)

(21) Appl. No.: 12/968,311

(22) Filed: Dec. 15, 2010

Related U.S. Application Data
(60) Provisional application No. 61/289,627, filed on Dec. 23, 2009.

(51) Int. Cl. B41M 5/44; B05D 5/12; B32B 3/10

(52) U.S. Cl. 428/32.86; 427/256; 428/195.1

(57) ABSTRACT

Provided are donor articles comprising a donor substrate and a conductive layer, wherein the conductive layer comprises (a) at least one electrically conductive polymer; (b) a binder comprising a polymer selected from the group consisting of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof; and (c) a polyanion. Also provided are methods of transferring at least a portion of an electrically conductive layer from such a donor article to a receiver, the patterned receivers and patterned donor articles made by such methods, electronic devices comprising the patterned receivers, and electronic devices comprising the patterned donor articles.

### CROSS REFERENCE TO RELATED APPLICATIONS

This application claims the benefit of priority of U.S. Provisional Application No. 61/289,627 filed on Dec. 23, 2009, which is herein incorporated by reference in its entirety.

### FIELD OF THE INVENTION

The present invention is directed to compositions that contain an electrically conducting polymer, a polyanion, and a binder. Such compositions can be used to prepare polymeric conductive donors that can be used in thermal transfer processes. The present invention also provides a method of transferring at least a portion of an electrically conductive layer from a donor article to a receiver, as well as the patterned receivers and patterned donor articles produced by the method. The present invention further relates to electronic devices comprising the patterned receivers, as well as electronic devices comprising the patterned donor articles.

### BACKGROUND

The high cost of the fabrication methods involving transparent electrically-conductive layers (TCL) of metal oxides and the low flexibility of such layers limit the range of potential applications. As a result, there is a growing interest in making all-organic devices, comprising flexible polymeric substrates and electrode layers made from organic electroconductive polymers. Certain pyrrole-containing polymers, thiophene-containing polymers, and aniline-containing polymers are known that are transparent and not prohibitively colored, at least when coated in thin layers. Conductive polymers have found use in a number of applications, for example in touch screens. Use of thermal transfer elements and thermal transfer methods for forming multicomponent devices has been proposed.

There remains a need for a suitable transfer element and a transfer method to form patterned conductive layers, especially those comprising electrically conductive polymers, on a receiver. There is also a need for incorporating such patterned conductive layers on a receiver or a donor article in electronic and/or optical devices.

### SUMMARY

One aspect of the present invention is a donor article comprising a donor substrate and an electrically conductive layer, wherein the conductive layer comprises:
(a) at least one electrically conductive polymer;
(b) a binder comprising a polymer selected from the group consisting of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof; and
(c) a polyanion.

Another aspect is a method of transferring at least a portion of an electrically conductive layer from a donor article to a receiver to provide a patterned receiver and a patterned donor article, the method comprising:

(a) providing a donor article comprising:
(i) a donor substrate; and
(ii) a conductive layer disposed on the donor substrate comprising an electrically conductive polymer, a polyanion, and a binder selected from the group consisting of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof;
   (b) contacting the conductive layer of the donor article with a receiver;
   (c) applying heat, pressure, or a combination thereof to at least a portion of the donor article to form a laminate; and
   (d) separating the laminate to provide a patterned donor article and a patterned receiver.

Yet another aspect is a patterned receiver comprising an electrically conductive layer, wherein the patterned receiver is made by the method provided herein above.

Another aspect is an electronic device comprising the patterned receiver.

Yet another aspect is a patterned donor article comprising an electrically conductive layer, wherein the patterned donor article is made by the method provided herein above.

Another aspect is an electronic device comprising the patterned donor article.

### BRIEF DESCRIPTION OF THE FIGURES

FIG. 1A shows a cross-sectional representation of a donor article 100 comprising a donor substrate 102 and a conductive layer 104 comprising an electrically conductive polymer, a polyanion, and a binder in contact with the donor substrate 102.

FIG. 1B shows a cross-sectional representation of a donor article 100 comprising a donor substrate 102, LTHC layer 106, and a conductive layer 104 comprising an electrically conductive polymer, a polyanion, and a binder in contact with the LTHC layer 106.

FIG. 1C shows a cross-sectional representation of a donor article 100 comprising a donor substrate 102, LTHC layer 106, release layer 108, conductive layer 104 comprising an electrically conductive polymer, a polyanion, and adhesion-promotion layer 110 in layered sequence.

FIG. 2 shows a cross-sectional representation of a donor element 100 comprising a donor substrate 102, LTHC layer 106, and conductive polymer composition 104 in contact with a receiver 202.

FIG. 3 shows a cross-sectional representation of a receiver 202 having a patterned conductive layer 104 that has been transferred selectively from a donor article.

FIG. 4 shows a cross-sectional representation of a display device on receiver 202 having multiple lines of a patterned conductive layer 104 that has been transferred selectively from a donor article.

### DETAILED DESCRIPTION

### Definitions

The methods disclosed herein are disclosed with reference to the following terms.

The term “device” means an electronic or optical component that can be used by itself or with other components to form a larger system, such as an electronic circuit.

The term “active device” means an electronic or optical component capable of a dynamic function, such as amplification, oscillation, or signal control, and which requires a source of energy for operation.

The term “passive device” means an electronic or optical component that is static in operation (i.e., it is ordinarily incapable of amplification or oscillation) and which does not require a source of energy for characteristic operation.

The term “operational layer” refers to layers that are utilized in the operation of a device, such as a multilayer active or passive device. Examples of operational layers include layers that act as insulating, conducting, semiconducting, superconducting, waveguiding, frequency multiplying, light producing (e.g., luminescing, light emitting, fluorescing or phosphorescing), electron-producing, hole-producing, magnetic, light-absorbing, reflecting, diffracting, phase-retarding, scattering, dispersing, refracting, polarizing, or diffusing layers in the device, in the layers that produce an optical or electronic gain in the device, or in both the device and such layers.

The term “auxiliary layer” is used herein to refer to layers that do not perform a function in the operation of the device, but are provided solely, for example, to facilitate transfer of a layer to a receiver element, to protect layers of the device from damage and/or contact with outside elements, and/or to adhere the transferred layer to the receiver.

As used herein, the term polyvinyl acetal refers to a group of polymers that are the product of reaction between polyvinyl alcohols and aldehydes. Polyvinyl alcohols are polymers containing various percentages of hydroxyl and acetate groups produced by hydrolysis of polyvinyl acetate. The conditions of the acetal reaction and the concentration of the particular aldehyde and polyvinyl alchol used are closely controlled to form polymers containing predetermined proportions of hydroxyl groups, acetate groups and acetal groups, which are randomly distributed along the polymer chain. The most widely used polyvinyl acetals include: (a) polyvinyl formaldehyde, produced from polyvinyl alcohol and formaldehyde; (b) polyvinyl acetaldehyde, produced from polyvinyl alcohol and acetaldehyde; and (c) polyvinyl butyraldehyde, produced from polyvinyl alcohol and butylaldehyde.

In one embodiment, a donor article is disclosed, the donor article comprising a donor substrate having thereon a conductive layer comprising at least one electrically conductive polymer, a polyanion, and a binder. The donor article can further comprise one or more other layers disposed on the conductive layer. Optionally, the donor article further comprises one or more other layers disposed between the donor substrate and the electrically conductive layer.

In some embodiments, the conductivity of the conductive layer is more than 0.01 siemens/centimeter (S/cm). For use in some applications, the conductivity is more than 10 S/cm, or more than 20 S/cm, or more than 30 S/cm. The conductivity is typically determined by a four-point probe technique.

In some embodiments, the conductive layer is transparent, with a transmission of greater than about 80% for wavelengths between about 400 nm to 800 nm. In some embodiments, the donor article is transparent.

The conductive layer need not form an integral whole, need not have a uniform thickness and need not be continuous. However, the conductive layer is generally contiguous to the donor substrate.

The donor substrate can be transparent, translucent, or opaque, rigid or flexible, colored or colorless. Donor substrates can include plastics, glass, metal, ceramic, semiconductors, or combinations thereof. “Plastic” means a high molecular weight polymer, usually made from polymeric synthetic resins, which may be combined with other ingredients such as curatives, fillers, reinforcing agents, colorants, and plasticizers. “Plastic” includes thermoplastic materials and thermosetting materials. Flexible plastic substrates can be any flexible self-supporting plastic film that supports the conductive layer.

Suitable plastics include thermoplastics of a relatively low Tg (glass transition temperature), for example up to 150° C., as well as materials of a higher Tg, for example, above 150° C. The choice of plastic depends on factors such as manufacturing process conditions (e.g., deposition temperature and annealing temperature) and post-manufacturing conditions. For some applications, a plastic substrate may be required to withstand processing temperatures of up to about 200° C., whereas other applications may require stability up to about 350° C.

In some embodiments, the donor substrate is transparent and is a flexible glass, ceramic or plastic substrate.

Suitable flexible plastic donor substrates comprise a material selected from the group consisting of polyesters, polyethersulfones (PES); polycarbonates (PC); polysulfones; phenolic resins; epoxy resins; polyimides; polyetheresters; polyetheramides; cellulose nitrate; cellulose acetate; poly(vinyl acetate); polystyrenes; polyolefins; polyolefin ionomers; polyamides; aliphatic polyurethanes; polyacrylonitriles; polytetrafluoroethylenes; polyvinylidene fluorides; polyarylates (PAR); polyetherimides (PEI); poly(perfluoro-alkoxy) fluoropolymers (PFA); poly(ether ether ketone) (PEEK); poly(ether ketone) (PEK); poly(ethylene tetrafluoroethylene)fluoropolymers (PETFE); poly(methyl methacrylate) (PMMA) copolymers; poly(acrylate) copolymers; papers; fabrics; voided polymers; polymeric foams; microvoided polymers; and microporous materials or any combinations thereof.

In one embodiment, the polyester is selected from the group consisting of polyethylene terephthalate (PET), polyethylene naphthalate (PEN), poly(butylene terephthalate), poly(1,4-cyclohexylene dimethylene terephthalate), and polyester ionomer or a combination thereof. Suitable polyesters include homo-polyesters, co-polyesters, and blends thereof. The polyester can be crystalline, amorphous, or a blend thereof.

Suitable aliphatic polyolefins include high density polyethylene (HDPE), low density polyethylene (LDPE), and polypropylene, including oriented polypropylene (OPP).

Suitable paper may be made from natural or synthetic materials. In one embodiment, the paper is resin-coated paper or laminated paper.

“Voided polymers” are defined herein as polymers consisting of a polymeric matrix containing voids in an open and/or closed cell arrangement. As used herein, a “polymeric foam” means a polymeric material formed by trapping gaseous bubbles in a polymer matrix. Herein the terms “microvoided polymers” and “microporous materials” refer to voided polymers and porous materials having void and pore sizes from about 0.1 microns to about 10 microns in diameter. As used herein, the terms “void” and “pore” are used interchangeably to mean devoid of solid or liquid matter. The voids, pores, and bubbles in polymeric materials and foams are typically disordered and of a variety of sizes.

In some embodiments, the flexible plastic donor substrates comprise polyesters or cellulose acetate (e.g., triacetylcellulose, TAC). A plasticizer can be added to cellulose acetate to increase the flexibility of the cellulose acetate film. Phosphoric esters or carboxylic esters such as phthalic esters and citric esters can be used as plasticizers. The amount of the plasticizer is typically in the range of 0.1 weight percent to 25 weight percent, or 1 weight percent to 20 weight percent, or 3 weight percent to 15 weight percent, based on the amount of cellulose acetate.

The donor substrate can be planar, curved, or bent. The donor substrate can be of any thickness that allows the substrate to be substantially self-supporting and preferably the minimum such thickness, such as, for example, 0.1 micron to 500 micron, or 10 micron to 200 micron. The donor substrate need not have a uniform thickness. Before the donor substrate is coated with the conductive layer, it can be physically and/or optically patterned, for example by rubbing, by the application of an image, by the application of patterned electrical contact areas, by the presence of one or more colors in distinct regions, or by embossing, microembossing, or microreplication.

The donor substrate can be formed by any method known in the art such as those involving extrusion, coextrusion, quenching, orientation, heat setting, lamination, coating and solvent casting. The donor substrate can be an oriented sheet formed by any suitable method known in the art, such as by a flat sheet process, or a bubble or tubular process. Alternatively, a plastic donor substrate can be formed by casting a solution of the substrate material on a drum or band and evaporating the solvent.

A polymer donor substrate can be subjected to coatings and treatments after casting, extrusion, coextrusion, or orientation, or between casting and full orientation, to improve and/or optimize its properties, such as printability, barrier properties, heat-sealability, spliceability, and adhesion to other substrates and/or imaging layers. Examples of such coatings include acrylic coatings for printability, and polyvinylidene halide for heat seal properties. Examples of suitable treatments include flame, plasma, and corona discharge treatment, ultraviolet radiation treatment, ozone treatment, electron beam treatment, acid treatment, alkali treatment, and saponification treatment to improve and/or optimize properties such as coatability and adhesion. Further examples of treatments include calendaring, embossing and patterning to obtain specific effects on the surface of the substrate. A polymer substrate can be further incorporated in any other suitable substrate by coating, lamination, adhesion, cold or heat sealing, extrusion, co-extrusion, or any other method known in the art.

Polymers suitable for use in the conductive layer as at least one electrically conductive polymer comprise a pyrrole-containing polymer, a thiophene-containing polymer, an aniline-containing polymer, or a combination thereof. In some embodiments, the at least one electrically conductive polymer comprises a blend of two or more electrically conductive polymers selected from the group consisting of pyrrole-containing polymers, thiophene-containing polymers, and aniline-containing polymers. The pyrrole-containing polymers, thiophene-containing polymers, and aniline-containing polymers may be substituted or unsubstituted, or mixtures thereof. In another embodiment, the conducting polymer comprises an unsubstituted polyaniline.

“Substituted” polymers are those in which one or more hydrogens attached to a carbon, nitrogen or sulfur of the unsubstituted polymer have been replaced by a substituent. Suitable substituents include C₁-C₁₈ alkyl groups, C₆-C₂₀ aryl groups, and C₁-C₁₀ alkoxy groups. The alkyl groups can be further substituted with aryl groups, and the aryl groups can comprise alkyl substituents. Suitable electrically conductive polymers include pyrrole-containing polymers (U.S. Pat. No. 5,665,498 and U.S. Pat. No. 5,674,654) and thiophene-containing polymers (U.S. Pat. No. 5,300,575). Preparation of thiophene-based polymers has been disclosed by L. B. Groenendaal, et al, “Poly(3,4-ethylenedioxythiophene) and its derivatives: past, present and future,” Advanced Materials, (2000), 12, No. 7, pp. 481-494, and references therein. Preparation of polyanilines and polypyrroles can be found, respectively, in “Polyaniline: protonic acid doping of the emeraldine form to the metallic regime” by J-C Chiang and A. G. MacDiamid, Synthetic Metals, 13 (1986), 193-205, and in U.S. Pat. No. 5,795,953, “Soluble electroconductive polypyrrole and method for preparing the same” by K. Y. Chung et al. More information on electrically conducting polymers can be found in: “Synthetic metals: a novel role for organic polymers by A. G. MacDiamid, Current Applied Physics, 1 (2001) 269-279; “Semiconducting and metallic polymers: the fourth generation of polymeric materials” by A. J. Heeger, Current Applied Physics, 1 (2001), 247-267; and “Handbook of Conducting Polymers”, Second Edition, Edited by T. A. Skotheim, R. L. Elsenbaumer and J. R. Reynolds, Marcel Dekker, Inc. New York, N.Y., 1998.

In one embodiment, the electrically conductive polymer comprises a thiophene-containing polymer comprising a cationic form of a polythiophene of Formula (I),

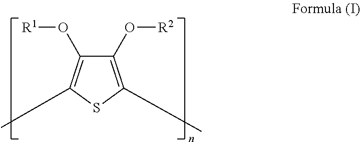

wherein:
n is an integer from 3 to 1000 inclusive; and each of R¹ and R² independently represents hydrogen or a C₁-C₄ alkyl group; or R¹ and R² are joined together and represent: an optionally substituted C₁-C₄ alkylene group or a cycloalkylene group; an optionally alkyl-substituted methylene group; an optionally C₁-C₁₂ alkyl- or phenyl-substituted 1,2-ethylene group; a 1,3-propylene group; or a 1,2-cyclohexylene group. Preferably, n is an integer from 20 to 400, inclusive.

Suitable electrically conductive polymer and polyanion combinations are soluble or dispersible in organic solvents, water, or mixtures thereof. In some embodiments, the electrically conductive polymer in its cationic form can form an aqueous solution in the presence of a polyanion.

Suitable polyanions for use in the conductive layer include anions of polymeric carboxylic acids and anions of polymeric sulfonic acids, or mixtures thereof. Suitable polymeric carboxylic acids include, for example, polyacrylic acids, poly(methacrylic acid), and poly(maleic acid). Suitable polymeric sulfonic acids include polystyrenesulfonic acids, polyvinylsulfonic acids, fluorinated polymeric sulfonic acids, and perfluoroalkylenesulfonic acids, for example. In one embodiment, the polymeric sulfonic acid is a polystyrenesulfonic acid. The polycarboxylic and polysulfonic acids can also be copolymers formed from vinylcarboxylic and vinylsulfonic acid monomers copolymerized with other polymerizable monomers such as the esters of acrylic acid and styrene. The molecular weight of the polyacids providing the polyanions is typically from about 1,000 to about 2,000,000, for example from about 2,000 to about 500,000. The polyacids or their alkali salts are commonly available, for example as polystyrenesulfonic acids and polyacrylic acids, or they may be produced using known methods. In some embodiments, mixtures of alkali salts of polyacids and appropriate amounts of monoacids can also be used to form the polyanions.

In some embodiments, the electrically conductive polymer is polythiophene, and the polythiophene to polyanion weight ratio is from 1:99 to 99:1, or from 85:15 to 15:85, or from 50:50 to 15:85.

In some embodiments, the electrically conductive polymer comprises poly(3,4-ethylene dioxythiophene styrene sulfonate), which comprises poly(3,4-ethylene dioxythiophene) in a cationic form and polystyrenesulfonic acid.

Suitable polymeric film-forming binders for use in the conductive layer include polymers selected from the group of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof. Suitable pol(2-alkyl-2-oxazoline) binders have C₁-C₄ alkyl substituents and include poly(2-ethyl-2-oxazoline). Suitable polyvinyl acetal binders included polyvinyl formaldehyde, polyvinyl acetaldehyde, and polyvinyl butyraldehyde.

In one embodiment, the electrically conductive layer comprises at least one electrically conductive polymer, a polyanion, and a binder selected from the group consisting of poly(2-ethyl-2-oxazoline) and poly(vinylpyrrolidone-co-vinyl acetate).

In one embodiment the polymer binders have good film forming properties, with a MW of greater than 20,000, or greater than 100,000. Details of properties and preparation of these binders can be found, for example in Polymer Handbook, Fourth edition, edited by J. Branddrup, E. H. Immergut, E. A. Grulke, John Wiley & Sons, Inc., New York, N.Y., 1999. Suitable binders can be obtained through commercial vendors. For example, poly(2-ethyl-2-oxazoline) and poly(vinylpyrrolidone-co-vinyl acetate)s are available from International Specialty Products (Wayne, N.J.) under the brand name Aquazol® and PVP/VA copolymers, respectively. Dispersions of polyvinyl butyraldehyde resin in water are available from Solutia Inc. (St. Louis, Mo.) under the tradenames Butvar® BR, FP, RS261 and RS3120.

The film-forming binder has been found to improve the physical properties of the conductive layer. The conductive layer can comprise from about 1 to 95 wt % of the film-forming polymeric binder. However, the film-forming binder may increase the overall surface electrical resistivity of the layer, so more typically the binder constitutes 20 to 80 wt %, or 30 to 70 wt %, of the conductive layer.

Other components that can be added to the conductive layer include, but are not limited to, surfactants, defoamers, coating aids, charge control agents, thickeners, viscosity modifiers, antiblocking agents, coalescing aids, crosslinking agents, hardeners, soluble and/or solid particle dyes, matte beads, inorganic or polymeric particles, adhesion promoting agents, bite solvents, chemical etchants, lubricants, plasticizers, antioxidants, and colorants or tints. The total quantity of such other components is preferably no more than 2 wt % of the conductive layer.

In one embodiment, the conductive layer is prepared by applying a mixture comprising a polythiophene, a polyanion and a binder selected from the group consisting of poly(2-ethyl-2-oxazoline) and poly(vinylpyrrolidone-co-vinyl acetate) to a suitable donor substrate. In some embodiments, the mixture also contains an aqueous or organic solvent that is removed after the application of the mixture to the donor substrate.

The conductive layer can be formed by air knife coating, gravure coating, hopper coating, curtain coating, roller coating, spray coating, electrochemical coating, inkjet printing, flexographic printing, stamping, or any well-known coating method.

In some embodiments, the conductive layer contains from about 1 to about 1000 mg/m², or from about 5 to about 500 mg/m² dry coating weight, of an electrically conductive polymer.

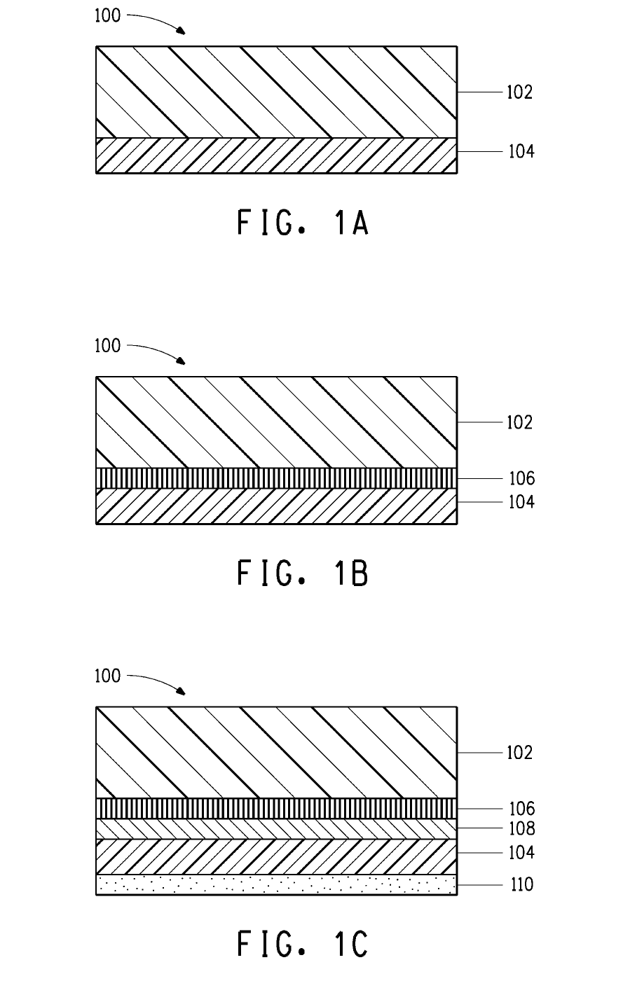

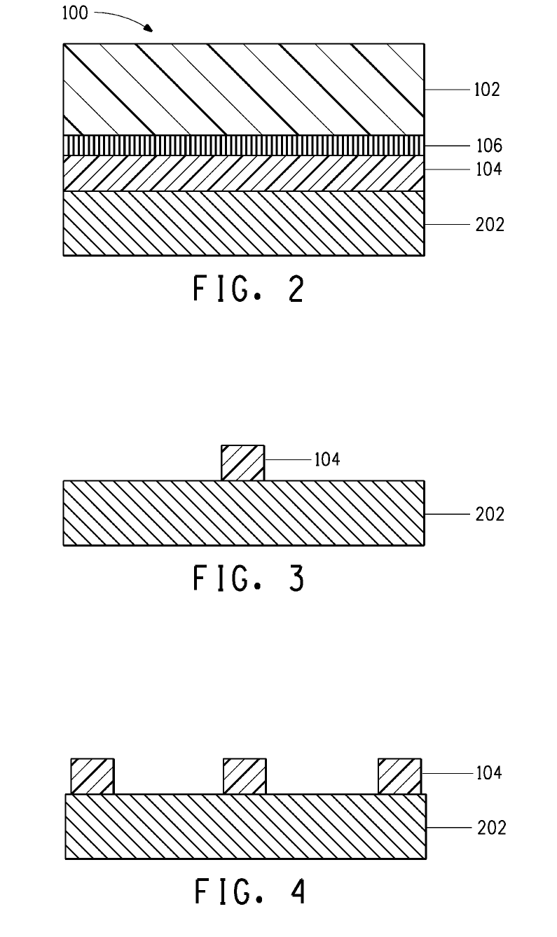

The donor article may further comprise one or more layers selected from the group consisting of a light-to-heat (LTHC) conversion layer, an adhesive layer, and a release layer. FIG. 1B is a cross-sectional view of a donor article 100 comprising a LTHC layer 106 interposed between the donor substrate 102 and the conductive layer 104.

The LTHC layer 106 can be incorporated as part of donor article 100 for radiation-induced thermal transfer to couple the energy of light radiated from a light-emitting source into the thermal transfer donor.

Typically, the radiation absorbing material in the LTHC layer (or other layers) absorbs light in the infrared, visible, and/or ultraviolet regions of the electromagnetic spectrum and converts the absorbed light into heat. The radiation absorber is typically highly absorptive, providing an optical density (OD) at the wavelength of the imaging radiation of from 0.1 to 10, or from 0.2 to 2, for example.

Suitable radiation absorbing materials include, for example, dyes (e.g., visible dyes, ultraviolet dyes, infrared dyes, fluorescent dyes, and radiation-polarizing dyes), pigments, metals, metal compounds, and metal films. A suitable LTHC layer can include a pigment, such as carbon black, and a binder, such as an organic polymer. Suitable near-infrared dyes include cyanine compounds such as indocyanines; phthalocyanines, including polysubstituted phthalocyanines and metal-containing phthalocyanines; and merocyanines.

Suitable dyes for LTHC layers and transfer layers include 3H-indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with trifluoromethanesulfonic acid (1:1) having CAS No. [128433-68-1] and molecular weight of about 619 grams per mole; 2-(2-(2-chloro-3-(2-(1,3-dihydro-1,1-dimethyl-3-(4-sulphobutyl)-2H-benz[e]indol-2-ylidene)ethylidene)-1-cyclohexene-1-yl)ethenyl)-1,1-dimethyl-3-(4-sulphobutyl)-1H-benz[e]indolium, inner salt, free acid having CAS No. [162411-28-1]; and indolenine dyes SDA 2860 and SDA 4733 from H. W. Sands Corp.

An LTHC layer can include a particulate radiation absorber and/or pigments in a binder. Examples of suitable pigments include carbon black and graphite.

The weight percent of the radiation absorber in the LTHC layer, excluding the solvent in the calculation of weight percent, is generally from 1 wt % to 85 wt %, depending on the particular radiation absorber(s) and binder(s) used in the LTHC layer. Suitable binders for use in the LTHC layer include film-forming polymers, such as phenolic resins (e.g., novolak and resole resins), polyvinyl butyral resins, polyvinyl acetates, polyvinyl acetals, polyvinylidene chlorides, polyacrylates, and styrene acrylics. The percent transmittance of the LTHC layer is affected by the identity and amount of the radiation absorber, and the thickness of the LTHC layer. The LTHC layer should exhibit radiation transmission in the range of about 20% to about 80% at the wavelength of the imaging radiation used in the thermal transfer imaging process. When a binder is present, the weight ratio of radiation absorber to binder is from about 5:1 to about 1:1000 by weight. A polymeric or organic LTHC layer is typically coated to a thickness of from 0.05 microns to 20 microns.

In some embodiments, the LTHC layer comprises a water-soluble or water-dispersible polymeric binder, with compositions as disclosed in U.S. Pat. No. 7,763,411 and WO 2006/045083. In some embodiments, the average particle size of a water-dispersible binder in its aqueous phase is less than 0.1 micron and has a narrow particle size distribution. Suitable water-soluble or water-dispersible polymeric binders for LTHC layers include acrylic resins, hydrophilic polyesters, and sulphonated polyesters.

Other suitable polymeric binders for LTHC layers include maleic anhydride homopolymers and copolymers, including those comprising functionality provided by treating the maleic anhydride polymers and/or copolymers with alcohols, amines, and/or alkali metal hydroxides. In some embodiments, suitable maleic anhydride-based copolymers comprise the structure represented by Formula (II)

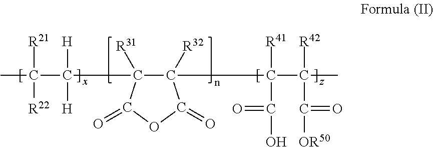

wherein x is any positive integer; y is zero or any positive integer; and z is zero or any positive integer, with the proviso that x is equal to (y+z) or x is greater than (y+z) in a ratio up to 9 parts x and 1 part (y+z);
R²¹ and R²² are the same or different and independently represent hydrogen, an alkyl group, an aryl group, an aralkyl group, a cycloalkyl group, or a halogen, with the proviso that one of R²¹ and R²² is an aryl group;
R³¹, R³², R⁴¹ and R⁴² are the same or different and independently represent hydrogen or a C₁-C₅ alkyl group; and
R⁵⁰ is a functional group selected from:

a) a C₁-C₂₀ alkyl, aralkyl, or alkyl-substituted aralkyl radical;

b) an oxyalkylated derivative of an alkyl, aralkyl, or alkyl-substituted aralkyl radical containing from two to four carbon atoms in each oxyalkylene group, wherein the oxyalkylated derivative comprises from one to twenty repeating units;

c) an unsaturated moiety;

d) a moiety containing a heteroatom; or

e) a cation selected from Li⁺, Na⁺, K⁺ or NH₄⁺.

In one embodiment, the maleic anhydride polymer for LTHC layers comprises a copolymer of Formula (II), wherein R²¹, R³¹, R³², R³³, R⁴¹, R⁴², R⁴³, are individually hydrogen, R²² is phenyl, and R⁵⁰ is 2-(n-butoxy)ethyl. One example of a maleic anhydride copolymer useful in an LTHC layer is a styrene maleic anhydride copolymer such as SMA 1440H, a product of Sartomer Corporation, Exton, Pa. (now Cray Valley).

In some embodiments, the LTHC layer further comprises one or more release modifiers selected from the group consisting of quaternary ammonium cationic compounds; phosphate anionic compounds; phosphonate anionic compounds; compounds comprising from one to five ester groups and from two to ten hydroxyl groups; alkoxylated amine compounds; and combinations thereof.

Metal radiation absorbers can also be used as LTHC layers, either in the form of particles or as films. Suitable metal radiation absorbers include nickel, nickel/vanadium alloys, and chromium. The thickness of the heating layer depends on the optical absorption of the metals used. For chromium, nickel/vanadium alloy or nickel, a layer of 80-100 Angstroms in thickness is suitable.

The donor article comprises a donor substrate and a conductive layer disposed on the donor substrate comprising an electrically conductive polymer, a polyanion and a binder. The donor article can further comprise a LTHC layer disposed between the donor substrate and the conductive layer when a light source is utilized for applying heat to at least a portion of the donor article during the transfer process.

A light-attenuating agent may be present in a discrete layer or incorporated in one of the other functional layers of the donor element, such as the donor substrate or the LTHC layer. In one embodiment, the donor substrate comprises a small amount (typically 0.2% to 0.5% by weight of the donor substrate) of a light-attenuating agent such as a dye which can assist in the focusing of the radiation source onto the radiation-absorber in the LTHC layer during the thermal imaging step, thereby improving the efficiency of the transfer process. U.S. Pat. No. 6,645,681, incorporated herein by reference, describes this and other ways in which the donor substrate may be modified to assist in the focusing of a laser radiation source in which the equipment comprises an imaging laser and a non-imaging laser wherein the non-imaging laser has a light detector that is in communication with the imaging laser. The wavelength ranges at which the imaging and non-imaging laser operate (typically in the range from about 300 nm to about 1500 nm) determine the wavelength ranges in which the absorber(s) and/or diffuser(s) are active and inactive. For example, if the non-imaging laser operates in about the 670 nm region and the imaging laser at 830 nm, it is preferred that the absorber and/or diffuser operate to absorb or diffuse light in the 670 nm region, rather than in the 830 nm region. Herein, the light attenuating agent preferably absorbs or diffuses light in the visible region, and in one embodiment absorbs around 670 nm. Suitable light-attenuating agents are well known in the art and include the commercially available Disperse Blue 60 and Solvent Green 28 dyes and carbon black. Preferably the amount of light-attenuating agent is sufficient to achieve an optical density (OD) of 0.1 or greater at some wavelength of about 400 to about 750 nm, more preferably about 0.3 to about 1.5.

In one embodiment, the LTHC layer comprises one or more radiation absorber(s) selected from the group consisting of metal films selected from Cr and Ni; carbon black; graphite; and near-IR dyes with an absorption maxima in the range of about 600 nm to 1200 nm within the LTHC layer.

In one embodiment, the one or more radiation absorber(s) comprises a near-IR dye(s), with an absorption maximum in the range of about 600 nm to 1200 nm, comprising one or more water-soluble or water-dispersible radiation-absorbing cyanine compound(s) selected from the group consisting of indocyanines, phthalocyanines, and merocyanines; and the LTHC layer further comprises one or more water-soluble or water-dispersible polymeric binders selected from the group consisting of acrylic and styrene-acrylic resins, hydrophilic polyesters, sulphonated polyesters, and maleic anhydride homopolymers and copolymers.

In one embodiment, the donor substrate further comprises a light attenuating agent and is characterized by an optical density of 0.1 or greater at a wavelength of about 350 nm to about 1500 nm.

Optionally, the donor article can further comprise one or more layers on the conductive layer. The multiplicity of layers can include any number of additional layers such as antistatic layers; tie layers or adhesion-promoting layers; abrasion resistant layers; curl control layers; conveyance layers; barrier layers; splice-providing layers; UV, visible and/or infrared light absorption layers; optical effect-providing layers, such as antireflective and antiglare layers; waterproofing layers; adhesive layers; release layers; magnetic layers; interlayers; or imageable layers.

In some embodiments, the donor article comprises a release layer that is disposed between the LTHC layer and the conductive layer. The release layer facilitates separation of the conductive layer from the donor substrate during the transfer process. Suitable materials for use in the release layer include, for example, polyvinylbutyrals, cellulosics, polyacrylates, polycarbonates and poly(acrylonitrile-co-vinylidene chloride-co-acrylic acid).

The donor articles and transfer processes can be used to make devices and other objects using a variety of transfer mechanisms and donor article configurations. The donor articles of the invention can be used to form devices such as, for example, electronic circuitry, resistors, capacitors, diodes, rectifiers, electroluminescent lamps, memory elements, field effect transistors, bipolar transistors, uni-junction transistors, MOS transistors, metal-insulator-semiconductor transistors, charge coupled devices, insulator-metal-insulator stacks, organic conductor-metal-organic conductor stacks, integrated circuits, photodetectors, lasers, lenses, waveguides, gratings, holographic elements, filters (e.g., add-drop filters, gain-flattening filters, and cut-off filters), mirrors, splitters, couplers, combiners, modulators, sensors (e.g., evanescent sensors, phase modulation sensors, and interferometric sensors), optical cavities, piezoelectric devices, ferroelectric devices, thin film batteries, and combinations thereof. For example, field effect transistors and organic electroluminescent lamps can be used in combination as an active matrix array for an optical display.

The donor articles can be used for forming a polymer dispersed liquid crystal display, an organic light-emitting diode (OLED) based display, or a resistive-type touch screen.

Also disclosed herein is a method of transferring at least a portion of an electrically conductive layer from a donor article to a receiver to provide a patterned receiver and a patterned donor article, the method comprising:

(a) providing a donor article comprising:
(i) a donor substrate; and
(ii) a conductive layer disposed on the donor substrate comprising an electrically conductive polymer, a polyanion, and a binder selected from the group consisting of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof;
   (b) contacting the conductive layer of the donor article with a receiver;
   (c) applying heat, pressure, or a combination thereof to at least a portion of the donor article to form a laminate; and
   (d) separating the laminate to provide a patterned donor article and a patterned receiver.

In one embodiment, the conductive layer comprises an electrically conductive polymer, a polyanion, and a binder selected from the group consisting of a poly(2-ethyl-2-oxazoline) and poly(vinylpyrrolidone-co-vinyl acetate).

Also disclosed herein is a patterned receiver comprising an electrically conductive layer, wherein the patterned receiver is made by the method of transferring at least a portion of an electrically conductive layer from a donor article to a receiver as disclosed herein above. In one embodiment, the electrically conductive layer comprises at least one electrically conductive polymer, a polyanion, and a binder selected from the group consisting of poly(2-ethyl-2-oxazoline) and poly(vinylpyrrolidone-co-vinyl acetate).

Also disclosed herein is an electronic device comprising a patterned receiver comprising an electrically conductive layer, wherein the patterned receiver is made by the method disclosed herein above. In one embodiment, the electronic device is a touchscreen sensor, an organic light-emitting diode, or a thin film transistor.

Further disclosed herein is a patterned donor article comprising an electrically conductive layer, wherein the patterned donor article is made by the method of transferring at least a portion of an electrically conductive layer from a donor article to a receiver as disclosed herein above. In one embodiment, the electrically conductive layer comprises at least one electrically conductive polymer, a polyanion, and a binder selected from the group consisting of poly(2-ethyl-2-oxazoline) and poly(vinylpyrrolidone-co-vinyl acetate).

Further disclosed herein is an electronic device comprising a patterned donor article comprising an electrically conductive layer, wherein the patterned donor article is made by the method disclosed herein above. In one embodiment, the electronic device is a touchscreen sensor, an organic light-emitting diode, or a thin film transistor.

The donor article can be heated by application of directed heat on a selected portion of the donor article. Heat can be generated by using a heating element (e.g., a resistive heating element), by converting radiation (e.g., a beam of light) to heat, and/or by applying an electrical current to a layer of the donor article to generate heat. In many instances, thermal transfer using light from a laser is advantageous because of the accuracy and precision that can often be achieved. The size and shape of the transferred pattern can be controlled by selecting the size of the light beam, the exposure pattern of the light beam, the duration of directed beam contact with the donor laminate, and the materials of the thermal transfer element. In this context, a “pattern” is defined as an arrangement of lines and shapes, e.g., a line, circle, square, or other shape.

In some embodiments, a laser is used to apply heat to a portion of the donor article to cause a portion of the conductive layer to transfer to the receiver. Suitable lasers include high power (>100 mW) single mode laser diodes, fiber-coupled laser diodes, and diode-pumped solid state lasers (e.g., Nd:YAG and Nd:YLF). Laser exposure dwell times can be in the range from, for example, about 0.1 to 100 microseconds and laser fluences can be in the range from about 0.01 to about 1 J/cm².

For laser transfer, the donor article is typically brought into intimate contact with a receiver. Pressure or vacuum can be used to hold the donor article in intimate contact with the receiver. A laser source is then used in an imagewise fashion (e.g., digitally or by analog exposure through a mask) to perform imagewise transfer of materials from the donor article to the receiver according to any pattern. In operation, a laser can be rastered or otherwise moved across the donor article and the receiver, the laser being selectively operated to illuminate portions of the donor article according to a desired pattern. Alternatively, the laser may be stationary and the donor article and receiver moved beneath the laser.

Laser thermal transfer can provide accurate registration when forming multiple devices over an area that is large compared to the device size. As an example, components of a display, which has many pixels, can be formed using this method.

When a laser or a light source is used for the transfer, a light-to-heat conversion layer is typically used to facilitate the transfer. In one embodiment, the step of applying heat, pressure, or a combination thereof to at least a portion of the donor article to form a laminate comprises utilizing a light source, and the donor article further comprises a light-to-heat conversion layer disposed between the donor substrate and the conductive layer.

When a light is used as the heat source to transfer a portion of the conductive layer to the receiver, it is necessary for either the donor substrate or the receiver substrate, or both, to be transparent to allow the light to be absorbed by the LTHC layer.

Alternatively, a heating element, such as a resistive heating element, can be used to effect the transfer. Typically, the donor article is selectively contacted with the heating element to cause thermal transfer of at least a portion of the conductive layer according to a pattern. In another embodiment, the donor article can include a layer that can convert an electrical current applied to the donor into heat.

Resistive thermal print heads or arrays can be useful with smaller substrate sizes (e.g., less than approximately 30 cm in any dimension) or for larger patterns, such as those required for alphanumeric segmented displays.

Pressure can be applied during the transfer operation using either mechanically or acoustically generated force. Mechanical force can be generated by a variety of methods well known in the art, for example, by contacting the donor article and receiver between opposing nip rollers. The nip rollers can be smooth or one or both rollers can have an embossed pattern. Alternatively, the mechanical force can be generated by the action of a stylus upon either the donor substrate or receiver when they are in intimate contact. The donor and receiver can be contacted in a stamping press using either smooth or patterned platens. Another method of applying mechanical force includes the use of acoustic force. Acoustic force can be generated using a transducer to pass acoustic energy through an acoustic lens, which in turn focuses its received acoustic energy into a small focal area of the donor article when it is in intimate contact with the receiver.

To facilitate the transfer process, the surface of the donor article in contact with the receiver can be an adhesive layer. Alternatively, the surface of the receiver in contact with a donor article can be an adhesive layer. The adhesive layer can be a pressure-sensitive adhesive layer comprising a low Tg polymer, a heat-activated adhesive layer comprising a thermoplastic polymer, or a thermal- or radiation-curable adhesive layer. Examples of suitable polymers for use in the adhesive layer include acrylic polymers, styrenic polymers, polyolefins, polyurethanes, and other polymers well known in the adhesives industry.

The receiver substrate can be any substrate described herein above for the donor substrate. Suitable materials include, but are not limited to, transparent films, display black matrices, passive and active portions of electronic displays, metals, semiconductors, glass, various papers, and plastics. Non-limiting examples of receiver substrates which can be used include anodized aluminum and other metals, plastic films (e.g., polyethylene terephthalate, polypropylene), indium tin oxide (ITO)-coated plastic films, glass, ITO-coated glass, flexible circuitry, circuit boards, silicon or other semiconductors, different types of paper (e.g., filled or unfilled, calendered, or coated), textiles, and woven or non-woven polymers. In one embodiment, the receiver comprises glass, polyethylene terephthalate, polyethylene naphthalate, polycarbonate, polyimide, triacetyl cellulose, or a combination thereof. Various layers (e.g., an adhesive layer) can be coated onto the receiver substrate to facilitate transfer of the transfer layer to the receiver substrate. Other layers can be coated on the receiver substrate to form a portion of a multilayer device.

In some embodiments, multiple donor articles can be used to form a device or other object. The multiple donor articles can include donor articles having two or more layers and donor articles that transfer a single layer.

For example, one donor article can be used to form a gate electrode of a field effect transistor. The gate insulating layer and semiconducting layer can be formed using any conventional method and materials, and yet another donor article can be used to form the source and drain contacts. Other combinations of two or more donor articles can be used to form a device.

A wide variety of donor article configurations employing various combinations of operational layers and auxiliary layers can be used, depending on the type of device that is being constructed and the transfer means being employed.

An active or passive device can be formed, at least in part, by the transfer of at least a portion of the electrically conductive layer from a donor article by bringing the side of the donor article bearing the conductive layer into contact with a receiver, applying heat, pressure, or a combination thereof to at least a portion of the donor article and/or receiver to form a laminate, and then separating the laminate by separating the donor article from the receiver element. Separating the laminate provides a patterned donor article and a patterned receiver. In at least some instances, pressure or vacuum can be used to hold the transfer donor article in intimate contact with the receiver during the application of heat and/or pressure.

In one embodiment, the receiver substrate forms at least a portion of a device, for example, a display device. The display device typically comprises at least one imageable layer wherein the imageable layer can contain an electrically imageable material. The electrically imageable material can be light-emitting or light-modulating. Light-emitting materials can be inorganic or organic, and include organic light-emitting diodes (OLED) and polymeric light-emitting diodes (PLED). The light-modulating material can be reflective or transmissive. Light-modulating materials can be electrochemical; electrophoretic, such as Gyricon particles; electrochromic; or liquid crystals. The liquid crystalline material can be twisted nematic (TN), super-twisted nematic (STN), ferroelectric, magnetic, or chiral nematic liquid crystals. The chiral nematic liquid crystals can be polymer dispersed liquid crystals (PDLC).

After transferring the conductive layer and any other operational or auxiliary layers to the receiver, the patterned receiver comprising the conductive layer can be incorporated in a device as one or more conducting electrodes. In some such cases, the transparent conductive layer preferably has at least one electric lead attached to (in contact with) it for the application of current or voltage (i.e., electrically connected). The lead(s) is/are preferably not in electrical contact with the substrate and can be made of patterned, deposited metal, conductive or semiconductive material, (e.g., ITO); a simple wire in contact with the conducting polymer; and/or conductive paint comprising a conductive polymer, carbon, and/or metal particles.

Devices incorporating transparent conductive polymers can be used in displays for notebook and desktop computers, instrument panels, touch screens, video game machines, videophones, mobile phones, handheld PCs, PDAs, e-books, camcorders, satellite navigation systems, store and supermarket pricing systems, highway signs, informational displays, smart cards, toys, and other electronic devices.

Display applications also include OLEDs and PLEDs. OLEDs are often manufactured by first depositing a transparent electrode on the substrate, and patterning the same into electrode portions. The organic layer is then deposited over the transparent electrode. A metallic electrode can be formed over the organic layers. The thermal transfer process and donor article described herein can be used to provide the electrode in most OLED device configurations, as an anode and/or any other operational or non-operational layer. These include very simple structures comprising a single anode and cathode to more complex devices, such as passive matrix displays containing orthogonal arrays of anodes and cathodes that form pixels, and active-matrix displays where each pixel is controlled independently, for example, with thin film transistors (TFTs).

For many applications, specific functional layers in devices have patterned structures. Patterning of color filters, black matrix, spacers, polarizers, conductive layers, transistors, phosphors, and organic electroluminescent materials have all been proposed. In some embodiments, a patterned structure can be obtained by (i) pre-patterning all or any part of the transfer layer before transfer, (ii) patterning all or any part of the transfer layer after transfer, and (iii) pattern-wise transfer of all or any part of the transfer layer during transfer.

A field effect transistor (FET) can be formed using one or more donor articles. One example of an organic field effect transistor that could be formed using donor articles is described in Garnier, et al., Adv. Mater. 2, 592-594 (1990). Similar examples are illustrated in U.S. Pat. No. 6,586,153 and references therein.

While the invention is amenable to various modifications and alternative forms, specifics thereof have been shown by way of example in the drawings and described in detail. It should be understood, however, that the intention is not to limit the invention to the particular embodiments described. On the contrary, the intention is to cover all modifications, equivalents, and alternatives falling within the spirit and scope of the invention.

### EXAMPLES

The present invention is further defined in the following Examples. These Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

Unless otherwise indicated, chemicals were used as received from vendors without further purification. The following materials are used in the examples:

BAYTRON P HC V4 is a form of polyethylene dioxythiophene-poly(styrenesulfonate) dispersion (about 1.3 wt % solids, PEDOT-PSSA), obtained from H C Starck Corp, Newton, Mass. This material was used as the source of an electrically conductive polymer doped with poly(styrenesulfonate) as the polyanion.

PVP-VA E-335 (50 wt % solution in ethanol; 30/70 VP/VA), E-535 (50 wt % solution in ethanol; 50/50 VP/VA), S-630 and W-735 (50 wt % solution in water; 70/30 VP/VA) are copolymers of vinylpyrrolidone (VP) and vinyl acetate (VA) in various ratios in solution or solid form and were obtained from International Specialty Products, Wayne, N.J.

Aquazol® 50 is poly(2-ethyl-2-oxazoline), obtained from International Specialty Products, Wayne, N.J.

Resyn® 1025 is a polyvinyl alcohol stabilized polyvinyl acetate emulsion, obtained from Nacan Products Limited, Brampton, ON, Canada.

PVP is polyvinylpyrrolidone of MW˜29,000, obtained from Sigma-Aldrich Chem. Co., St. Louis, Mo.

Melinex® ST 504 polyester film (DuPont Teijin Film, Hopewell, Va.), which had been treated for higher thermal stability

TEGO WET 251(4) is a polyether modified polysiloxane copolymer obtained from Evonik-Degussa Industries, Inc., Newark, Del. 19713.

Hampford dye 822 was obtained from Hampford Research, Straitford, Conn. 06615.

The polyester binder (Ameritech Polyester Clear) was obtained from American Inks and Coatings Corp, Valley Forge, Pa.

The aqueous potassium dimethylaminoethanol ethyl phosphate solution was prepared by combining three parts water and 0.5 parts ethyl acid phosphate (Lubrizol, Wickliffe, Ohio) and sufficient 45% aqueous potassium hydroxide to achieve a pH of 4.5, followed by addition of sufficient dimethylaminoethanol to achieve a pH of 7.5 and finally dilution with water to achieve five parts total of final aqueous solution of 11.5 relative mass percent of water-free compound.

CYMEL 350, a crosslinker, is a highly methylated, monomeric melamine formaldehyde resin obtained from Cytec Industries Inc., West Paterson, N.J.

Unless otherwise stated, all percentages are weight percents.

An organic LTHC layer was prepared by adding 5 g of dimethylaminoethanol and 10 g of Hampford dye 822 (formula corresponds to SDA 4927) to demineralised water (894 g). After allowing the mixture to stir for up to 24 hr, the following ingredients were added in the order given: 65 g of a 30% aqueous solution of a polyester binder (Ameritech Polyester Clear); 2.5 g of TEGO WET 251(4); 14 g of an 11.5% aqueous solution of potassium dimethylaminoethanol ethyl phosphate; 10 g of an aqueous 20% solution of CYMEL 350; and 2 g of a 10% aqueous solution of ammonium p-toluene sulphonic acid.

The formulation was applied in an in-line coating technique as follows: A PET base film composition was melt-extruded, cast onto a cooled rotating drum and stretched in the direction of extrusion to approximately 3 times its original dimensions at a temperature of 75° C. The cooled, stretched film was then coated on one side with the LTHC coating composition to give a wet coating thickness of approximately 20 to 30 microns. A direct gravure coating system was used to apply the LTHC coating to the PET film. A 60QCH gravure roll (supplied by Pamarco) rotated through the solution, taking solution onto the gravure roll surface. The gravure roll rotated in the opposite direction to the film web and applied the coating to the web at one point of contact. The coated film was passed into a stenter oven at a temperature of 100-110° C., where the film was dried and stretched in the sideways direction to approximately 3 times its original dimensions. The biaxially stretched coated film was heat-set at a temperature of about 190° C. by conventional means. The coated polyester film was then wound onto a roll. The total thickness of the final film was 50 microns; the dry thickness of the transfer-assist coating layer was 0.07 microns.

The PET base film contained either Disperse Blue 60 or Solvent Green 28 dye to give a final dye concentration of typically 0.2% to 0.5% by weight in the polymer of the base film. The base film containing the Disperse Blue 60 dye (0.26% by weight) had an absorbance of 0.6±0.1 at 670 nm, and an absorbance of less than 0.08 at 830 nm. The base film containing the Solvent Green 28 dye (0.40% by weight) had an absorbance of 1.2 at 670 nm, and an absorbance of less than 0.08 at 830 nm. The coated base films are herein referred to as: Organic LTHC Blue PET base film and Organic LTHC Green PET base film.

Creo Trendsetter® 800 (Creo, Vancouver, Canada, now owned by Kodak Graphic Communications Group, Rochester, N.Y., USA) was one of the two printers used for thermal imaging. The Creo Trendsetter® 800 was a modified drum-type imager with a modified Thermal 1.7 Head and a 12.5 watt maximum average operating power at a wavelength of 830 nm with 5080 dpi resolution. The Trendsetter® 800 was operated in a controlled temperature/humidity environment with an average temperature of ˜68° C. and an average relative humidity of ˜40-50%.

A Creo Trendsetter® 3244 was also used for thermal imaging. The Creo Trendsetter® 3244 is a standard drum-type imager which uses a Thermal 1.7 Head with a 20 watt maximum average operating power at a wavelength of 830 nm with 2400 dpi resolution. The 3244 Trendsetter® was operated under ambient conditions.

For each printing experiment, a section of the thermal imaging receiver was positioned on the drum. The thermal imaging donor was loaded so that the side of the donor element coated with the transfer layer was facing the free side of the receiver. Films were mounted using vacuum hold-down to a standard plastic or metal carrier plate clamped mechanically to the drum. In some experiments using the Creo Trendsetter® 800 thermal platesetter, a nonstandard drum with vacuum holes machined directly onto the drum to match common donor and receiver sizes was used as a replacement for the standard drum/carrier plate assemblage. Contact between the donor and receiver was established by ˜600 mm of Hg vacuum pressure. Imaging assemblages were exposed from the back side through the donor film base. Laser output was under computer control to build up the desired image pattern. Laser power and drum speed were controllable and were adjusted in an iterative fashion to optimize image quality as judged by visual inspection of the transferred image on the receiving surface.

The sheet resistance and conductivity of conducting lines produced by the above thermal imaging process were obtained by measuring the resistance of lines with known geometries. A Cascade MicroTech (Beaverton, Oreg.) probe station model Alessi REL-6100 and a semiconductor parameter analyzer Agilent Technologies (Palo Alto, Calif.) model 4155C were used to apply a current across the lines and measure voltage drops at two known positions within the line. Typically, currents were swept from 1×10⁻⁵ to −1×10⁵ A to obtain voltages in the mV to V range. The slope of the I-V curve and the line geometry were used to obtain resistance and resistivity. From these values conductivity can be calculated.

The thickness of the transparent conducting layer was measured with a Tencor P-15 stylus profilometer (KLA-Tencor, San Jose, Calif.).

### Example 1

This Example illustrates formulating a 50/50 by weight percent [polyethylene dioxythiophene-polystyrenesulfonate]-[poly(vinylpyrrolidone-co-vinyl acetate)] (PEDOT-PSSA-PVP-VA) composition, coating the composition onto a PET donor substrate to provide a donor article comprising a donor substrate and a conductive layer, and using the donor article to print a pattern onto a receiver. In the printing process, a portion of the electrically conductive layer from the donor article was selectively transferred to the receiver.

A mixture of PVP-VA E335 (0.244 g of a 50 wt % solution in ethanol) and isopropyl alcohol (IPA) (0.5003 g) was added slowly (drop-wise) into a mixture of Baytron P HC V4 (10.000 g of an approximately 1.3 wt % aqueous solution) and dimethyl sulfoxide (0.500 g) while stirring. The mixture was stirred for 15 min after completion of the addition process. The resulting mixture was filtered with a 2.0 micron Whatman® MGF-150 syringe-disc filter (Whatman Inc., Clifton, N.J.).

The donor free surface of the Organic LTHC Green PET donor substrate was cleaned with a pressurized nitrogen stream immediately prior to coating to rid the surface of particle contamination. Coating of the 50 wt % PEDOT-PVP-VA composition onto the Organic LTHC Green PET donor substrate was carried out using chrome-plated stainless steel formed 0.625 inch diameter rods with a CN profile (Buschman Corporation, Cleveland, Ohio). The coatings were drawn on to the Organic LTHC Green PET donor substrate using a CN#14 rod at 5.8 ft/min utilizing a WaterProof® Color Versatility coating system (E. I. du Pont de Nemours and Company, Wilmington, Del.). The wet films were dried for 30 min at 46° C.

The printing was carried out on a Creo Trendsetter® 800 as detailed above. A section of thermal imaging receiver (Melinex® ST 504 film, DuPont Teijin Film) was loaded into a Creo Trendsetter® 800 thermal platesetter. Subsequently, a thermal-imaging donor fashioned as described above using the composition of Example 1 was loaded so that the coated side of the donor was facing the receiver. Contact between the donor and receiver was established by 600 mm of Hg vacuum pressure. Using the Creo Trendsetter® 800 thermal platesetter, a conductor pattern was imaged. The donor element was imaged at 3.25, 3.50, 3.75, 4.00, 4.25, 4.50, and 4.75 W, a surface depth of 50, and a drumspeed of 60 rpm. Immediately after imaging, the donor/receiver sheets were removed from the Trendsetter® 800 and peeled apart to provide a printed layer on the receiver (for example, 1 mm lines with spacing).

The printed patterns were evaluated visually (optical microscope) for imaging quality and the best-printed pattern was characterized for its resistance, transmission and thickness. Conductivity of a representative printed pattern was calculated from the resistance data and the geometries of the printed patterns. The conductivity and printing condition are listed in Table 1.

### Examples 2-6

Examples 2-6 were formulated, coated, printed and characterized in a similar fashion to Example 1, except that that no IPA was used. In Example 2, the PEDOT content in the donor film was 30%, and coating rod CN#9 was used. CN#13 was used for Examples 3, 5 and 6; CN#11 was used for example 4. In Examples 2 and 4, printing was performed using the Creo Trendsetter® 3244.

### Comparative Examples A and B

Comparative Examples A and B were formulated, coated, printed and characterized in a similar fashion to Example 1, except for the following changes. No IPA was used, and instead of PVP-VA as the binder, PVA Resyn 1025 was used in Comparative Example A, and PVP was used in Comparative Example B. Also, a coating rod CN#11 was used for Comparative Example A; CN#13 was used for Comparative Example B.

TABLE 1
Composition, Printing and Characterization of Examples and
Comparative Examples. In the table, PEDOT-PSSA refers to Baytron P HC V4.

| | PEDOT-PSSA | | Polymer binder | | | Printing | |
|---|---|---|---|---|---|---|---|
| | Wt % in | Amount of | | Dry | DMSO | parameter | |
| | donor | solution | | weight | Used | Speed/Power | Conductivity |
| Example | film | used (g) | Name of Binder | (g) | (g) | (rpm/Watt) | (S/cm) |
| 1 | 50 | 10.000 | PVP-VA | 0.122 | 0.500 | 60/3.75 | 32 |
| | | | E335 | | | | |
| 2 | 30 | 30.014 | PVP-VA | 0.854 | 1.501 | 80/9.25 | 20 |
| | | | E335 | | | | |
| 3 | 50 | 10.000 | PVP-VA | 0.123 | 0.500 | 60/3.50 | 49 |
| | | | E-535 | | | | |
| 4 | 50 | 14.061 | PVP-VA | 0.173 | 0.711 | 80/9.75 | 43 |
| | | | S-630* | | | | |
| 5 | 50 | 10.000 | PVP-VA | 0.199 | 0.500 | 60/5.00 | 31 |
| | | | W-735 | | | | |
| 6 | 50 | 10.000 | Aquazol ® 50* | 0.128 | 0.500 | 60/5.00 | 54 |
| Comp. | 50 | 10.000 | PVA | 0.131 | 0.500 | 60/4.50 | 13 |
| Ex. A | | | Resyn 1025 | | | | |
| Comp. | 50 | 10.000 | PVP* | 0.125 | 0.500 | 60/4.75 | 18 |
| Ex. B | | | | | | | |

*10% solution in water was prepared before mixing.

The data in the Table show that the conductivity of the conductive layers prepared and transferred in Examples 1-6 are significantly higher than the conductivities of the conductive layers prepared and transferred in the Comparative Examples when compared at the same weight percent in the donor film of the PEDOT-PSSA.

What is claimed is:

1. A donor article comprising a donor substrate and an electrically conductive layer, wherein the conductive layer comprises:
(a) at least one electrically conductive polymer;
(b) a binder comprising a polymer selected from the group consisting of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof; and
(c) a polyanion.

2. The donor article of claim 1, wherein the at least one electrically conductive polymer comprises a pyrrole-containing polymer, a thiophene-containing polymer, an aniline-containing polymer, or a combination thereof.

3. The donor article of claim 2, wherein the thiophene-containing polymer comprises a cationic form of a polythiophene of Formula (I), 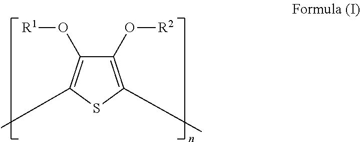
wherein:
n is an integer from 3 to 1000 inclusive; and
each of R¹ and R² independently represents hydrogen or a C₁-C₄ alkyl group; or R¹ and R² are joined together and represent an optionally substituted C₁-C₄ alkylene group or a cycloalkylene group; an optionally alkyl-substituted methylene group; an optionally C₁-C₁₂ alkyl- or phenyl-substituted 1,2-ethylene group; a 1,3-propylene group; or a 1,2-cyclohexylene group.

4. The donor article of claim 1, wherein the donor substrate comprises a material selected from the group consisting of: polyesters; polyethersulfones; polycarbonates; polysulfones; phenolic resins; epoxy resins; polyimides; polyetheresters; polyetheramides; cellulose nitrate; cellulose acetate; poly(vinyl acetate); polystyrenes; polyolefins; polyolefin ionomers; polyamides; aliphatic polyurethanes; polyacrylonitriles; polytetrafluoroethylenes; polyvinylidene fluorides; polyarylates; polyetherimides; poly(perfluoro-alkoxy)fluoropolymers; poly(ether ether ketone); poly(ether ketone); poly(ethylene tetrafluoroethylene)fluoropolymers; poly(methyl methacrylate) copolymers; poly(acrylate) copolymers; papers; fabrics; voided polymers, polymeric foams; microvoided polymers; and microporous materials or any combinations thereof.

5. The donor article of claim 1, wherein the polyanion is selected from the group consisting of anions of polymeric carboxylic acids and anions of polymeric sulfonic acids, or mixtures thereof.

6. The donor article of claim 5, wherein the polymeric sulfonic acid is a polystyrenesulfonic acid.

7. The donor article of claim 1, further comprising one or more layers selected from the group consisting of a light-to-heat conversion layer, an adhesive layer, and a release layer.

8. The donor article of claim 7, wherein the one or more layers is a light-to-heat conversion layer, and the light-to-heat conversion layer comprises one or more radiation absorber(s) selected from the group consisting of metal films selected from Cr and Ni; carbon black; graphite; and near-IR dyes with an absorption maxima in the range of about 600 nm to 1200 nm within the LTHC layer.

9. The donor article of claim 8, wherein the one or more radiation absorber comprises a near-IR dye(s), with an absorption maximum in the range of about 600 nm to 1200 nm, comprising one or more water-soluble or water-dispersible radiation-absorbing cyanine compound(s) selected from the group consisting of indocyanines, phthalocyanines, and merocyanines; and the LTHC layer further comprises one or more water-soluble or water-dispersible polymeric binders selected from the group consisting of acrylic and styrene-acrylic resins, hydrophilic polyesters, sulphonated polyesters, and maleic anhydride homopolymers and copolymers.

10. The donor article of claim 1, wherein the donor substrate further comprises a light attenuating agent and is characterized by an optical density of 0.1 or greater at a wavelength of about 350 nm to about 1500 nm.

11. A method of transferring at least a portion of an electrically conductive layer from a donor article to a receiver to provide a patterned receiver and a patterned donor article, the method comprising:
(a) providing a donor article comprising:
(i) a donor substrate; and
(ii) a conductive layer disposed on the donor substrate comprising an electrically conductive polymer, a polyanion, and a binder selected from the group consisting of poly(2-alkyl-2-oxazoline), poly(vinylpyrrolidone-co-vinyl acetate), polyvinyl acetal, poly(3-morpholinylethylene), poly(2,4-dimethyl-6-triazinylethylene), poly(N-1,2,4-triazolylethylene), poly(vinylsulfate), poly(vinylformamide), and poly[N-(p-sulfophenyl)imino-3-hydroxymethyl-1,4-phenyleneimino-1,4-phenylene] or a combination thereof;
(b) contacting the conductive layer of the donor article with a receiver;
(c) applying heat, pressure, or a combination thereof to at least a portion of the donor article to form a laminate; and
(d) separating the laminate to provide a patterned donor article and a patterned receiver.

12. The method of claim 11, wherein the step of applying heat, pressure, or a combination thereof comprises utilizing a light source, and the donor article further comprises a light-to-heat conversion layer disposed between the donor substrate and the conductive layer.

13. The method of claim 11, wherein the receiver comprises glass, polyethylene terephthalate, polyethylene naphthalate, polycarbonate, polyimide, triacetyl cellulose, or a combination thereof.

14. A patterned receiver comprising an electrically conductive layer, wherein the patterned receiver is made by the method of claim 11.

15. An electronic device comprising the patterned receiver of claim 14.

16. The electronic device of claim 15, wherein the electronic device is a touchscreen sensor, an organic light-emitting diode, or a thin film transistor.

17. A patterned donor article comprising an electrically conductive layer, wherein the patterned donor is made by the method of claim 11.

18. An electronic device comprising the patterned donor article of claim 17.

19. The electronic device of claim 18, wherein the electronic device is a touchscreen sensor, an organic light-emitting diode, or a thin film transistor.
